(19) United States
(12) Patent Application Publication
(10) Pub. No.: US 2026/0181462 A1
(43) Pub. Date: Jun. 25, 2026

(54) System, Method, and Device for Imaging Using Wireless Network Signals

(71) Applicant: Carnegie Mellon University, Pittsburgh, PA (US)

(72) Inventors: Dong Huang, Sewickley, PA (US); Jun Liu, Pittsburgh, PA (US)

(21) Appl. No.: 19/535,371

(22) Filed: Feb. 10, 2026

Related U.S. Application Data
(63) Continuation of application No. PCT/US24/41069, filed on Aug. 6, 2024.
(60) Provisional application No. 63/531,997, filed on Aug. 10, 2023.

(51) Int. Cl. H04W 24/10; H04B 7/06

(52) U.S. Cl. CPC H04W 24/10; H04B 7/0626

(57) ABSTRACT

Provided are systems, methods, and devices for imaging using wireless network signals. The system includes a first set of wireless network antennas, a second set of wireless network antennas, and at least one computing device, the at least one computing device configured to initiate, with a first wireless network adapter, bidirectional communication of network packets between the first set of wireless network antennas and the second set of wireless network antennas, extract channel state information from the network packets after they are received by the first set of wireless network antennas and the second set of wireless network antennas, and generate an image of at least one entity in the space defined between the first set of wireless network antennas and the second set of wireless network antennas based on inputting the channel state information into a machine-learning model.

### CROSS REFERENCE TO RELATED APPLICATIONS

This application is a United States bypass continuation of International Application No. PCT/US24/41069 filed on Aug. 6, 2024, and claims the benefit of U.S. Provisional Patent Application No. 63/531,997, filed on Aug. 10, 2023, the disclosures of which are hereby incorporated by reference in their entireties.

### BACKGROUND OF THE INVENTION

### 1. Field

This disclosure relates generally to image generation and processing and, in non-limiting embodiments, to a systems, methods, and devices for imaging using wireless network signals.

### 2. Technical Considerations

Disorder and pathological changes of internal organs such as in cardiovascular diseases are one of the leading causes of death around the world. For cardiovascular diseases, the dominant prevention and treatment practices involve x-ray (ionizing radiation) computed tomography (CT) scans only available at large hospitals. Due to the long appointment gaps, tedious commutes, high prices, and risk of ionizing radiation, frequent x-ray CT scans are not practical for many patients and in many different situations. There are no existing systems or methods for creating three-dimensional (3D) volumes from wireless network signals.

### SUMMARY

According to non-limiting embodiments or aspects, provided is a system for imaging using wireless network signals comprising: a first set of wireless network antennas; a second set of wireless network antennas arranged a distance from the first set of wireless network antennas, wherein a space is defined between the first set of wireless network antennas and the second set of wireless network antennas; and at least one computing device in communication with the first set of wireless network antennas and the second set of wireless network antennas, the at least one computing device configured to: initiate, with a first wireless network adapter, bidirectional communication of network packets between the first set of wireless network antennas and the second set of wireless network antennas; extract channel state information from the network packets after they are received by the first set of wireless network antennas and the second set of wireless network antennas; and generate an image of at least one entity in the space defined between the first set of wireless network antennas and the second set of wireless network antennas based on inputting the channel state information into a machine-learning model.

In non-limiting embodiments or aspects, the system includes: a first enclosure comprising the first set of wireless network antennas; and a second enclosure comprising the second set of wireless network antennas. In non-limiting embodiments or aspects, wherein initiating the bidirectional communication of network packets comprises: switching the first set of wireless network antennas from operating as a transmitter to operating as a receiver at a predetermined time interval; and switching the second set of wireless network antennas from operating as the receiver to operating as the transmitter at the predetermined time interval. In non-limiting embodiments or aspects, the system includes a first wireless network adapter and a second wireless network adapter, the bidirectional communication of network packets between the first set of wireless network antennas and the second set of wireless network antennas is performed substantially simultaneously by the first wireless network adapter and the second wireless network adapter.

In non-limiting embodiments or aspects, the at least one computing device is further configured to: generate a tensor based on the channel state information, wherein inputting the channel state information into the machine-learning model comprises inputting the tensor into the machine-learning model. In non-limiting embodiments or aspects, wherein generating the tensor comprises encoding the channel state information into a 4D tensor based on 3D signal pathways between the first set of wireless network antennas and the second set of wireless network antennas. In non-limiting embodiments or aspects, the image comprises a 3-dimensional volume of pixels, and the at least one entity comprises an internal organ of an entity.

According to non-limiting embodiments or aspects, provided is a method comprising: initiating, with a first wireless network adapter, bidirectional communication of network packets between a first set of wireless network antennas and a second set of wireless network antennas, wherein a space is defined between the first set of wireless network antennas and the second set of wireless network antennas; extracting channel state information from the network packets after they are received by the first set of wireless network antennas and the second set of wireless network antennas; and generating an image of at least one entity in the space defined between the first set of wireless network antennas and the second set of wireless network antennas based on inputting the channel state information into a machine-learning model.

In non-limiting embodiments or aspects, the method includes arranging the first set of wireless network antennas in a first enclosure and the second set of wireless network antennas in a second enclosure. In non-limiting embodiments or aspects, wherein initiating the bidirectional communication of network packets comprises: switching the first set of wireless network antennas from operating as a transmitter to operating as a receiver at a predetermined time interval; and switching the second set of wireless network antennas from operating as the receiver to operating as the transmitter at the predetermined time interval. In non-limiting embodiments or aspects, the bidirectional communication of network packets between the first set of wireless network antennas and the second set of wireless network antennas is performed substantially simultaneously by a first wireless network adapter and a second wireless network adapter.

In non-limiting embodiments or aspects, the method includes: generating a tensor based on the channel state information, wherein inputting the channel state information into the machine-learning model comprises inputting the tensor into the machine-learning model. In non-limiting embodiments or aspects, wherein generating the tensor comprises encoding the channel state information into a 4D tensor based on 3D signal pathways between the first set of wireless network antennas and the second set of wireless network antennas. In non-limiting embodiments or aspects, the image comprises a 3D volume of pixels, and the at least one entity comprises an internal organ of an entity.

According to non-limiting embodiments or aspects, provided is a computer program product comprising at least one non-transitory computer-readable medium including program instructions that, when executed by at least one computing device, cause the at least one computing device to: initiate, with a first wireless network adapter, bidirectional communication of network packets between a first set of wireless network antennas and a second set of wireless network antennas, wherein a space is defined between the first set of wireless network antennas and the second set of wireless network antennas; extract channel state information from the network packets after they are received by the first set of wireless network antennas and the second set of wireless network antennas; and generate an image of at least one entity in the space defined between the first set of wireless network antennas and the second set of wireless network antennas based on inputting the channel state information into a machine-learning model.

In non-limiting embodiments or aspects, wherein initiating the bidirectional communication of network packets comprises: switching the first set of wireless network antennas from operating as a transmitter to operating as a receiver at a predetermined time interval; and switching the second set of wireless network antennas from operating as the receiver to operating as the transmitter at the predetermined time interval. In non-limiting embodiments or aspects, the bidirectional communication of network packets between the first set of wireless network antennas and the second set of wireless network antennas is performed substantially simultaneously by the first wireless network adapter and a second wireless network adapter. In non-limiting embodiments or aspects, the at least one computing device is further caused to: generate a tensor based on the channel state information, wherein inputting the channel state information into the machine-learning model comprises inputting the tensor into the machine-learning model. In non-limiting embodiments or aspects, wherein generating the tensor comprises encoding the channel state information into a 4D tensor based on 3D signal pathways between the first set of wireless network antennas and the second set of wireless network antennas. In non-limiting embodiments or aspects, the image comprises a 3D volume of pixels, and the at least one entity comprises an internal organ of an entity.

Other non-limiting embodiments or aspects will be set forth in the following numbered clauses:

Clause 1: A system for imaging using wireless network signals comprising: a first set of wireless network antennas; a second set of wireless network antennas arranged a distance from the first set of wireless network antennas, wherein a space is defined between the first set of wireless network antennas and the second set of wireless network antennas; and at least one computing device in communication with the first set of wireless network antennas and the second set of wireless network antennas, the at least one computing device configured to: initiate, with a first wireless network adapter, bidirectional communication of network packets between the first set of wireless network antennas and the second set of wireless network antennas; extract channel state information from the network packets after they are received by the first set of wireless network antennas and the second set of wireless network antennas; and generate an image of at least one entity in the space defined between the first set of wireless network antennas and the second set of wireless network antennas based on inputting the channel state information into a machine-learning model.

Clause 2: The system of clause 1, further comprising: a first enclosure comprising the first set of wireless network antennas; and a second enclosure comprising the second set of wireless network antennas.

Clause 3: The system of clause 1 or 2, wherein initiating the bidirectional communication of network packets comprises: switching the first set of wireless network antennas from operating as a transmitter to operating as a receiver at a predetermined time interval; and switching the second set of wireless network antennas from operating as the receiver to operating as the transmitter at the predetermined time interval.

Clause 4: The system of any of clauses 1-3, further comprising a first wireless network adapter and a second wireless network adapter, wherein the bidirectional communication of network packets between the first set of wireless network antennas and the second set of wireless network antennas is performed substantially simultaneously by the first wireless network adapter and the second wireless network adapter.

Clause 5: The system of any of clauses 1-4, wherein the at least one computing device is further configured to: generate a tensor based on the channel state information, wherein inputting the channel state information into the machine-learning model comprises inputting the tensor into the machine-learning model.

Clause 6: The system of any of clauses 1-5, wherein generating the tensor comprises encoding the channel state information into a 4D tensor based on 3D signal pathways between the first set of wireless network antennas and the second set of wireless network antennas.

Clause 7: The system of any of clauses 1-6, wherein the image comprises a 3-dimensional volume of pixels, and wherein the at least one entity comprises an internal organ of an entity.

Clause 8: A method comprising: initiating, with a first wireless network adapter, bidirectional communication of network packets between a first set of wireless network antennas and a second set of wireless network antennas, wherein a space is defined between the first set of wireless network antennas and the second set of wireless network antennas; extracting channel state information from the network packets after they are received by the first set of wireless network antennas and the second set of wireless network antennas; and generating an image of at least one entity in the space defined between the first set of wireless network antennas and the second set of wireless network antennas based on inputting the channel state information into a machine-learning model.

Clause 9: The method of clause 8, further comprising arranging the first set of wireless network antennas in a first enclosure and the second set of wireless network antennas in a second enclosure.

Clause 10: The method of clause 8 or 9, wherein initiating the bidirectional communication of network packets comprises: switching the first set of wireless network antennas from operating as a transmitter to operating as a receiver at a predetermined time interval; and switching the second set of wireless network antennas from operating as the receiver to operating as the transmitter at the predetermined time interval.

Clause 11: The method of any of clauses 8-10, wherein the bidirectional communication of network packets between the first set of wireless network antennas and the second set of wireless network antennas is performed substantially simultaneously by a first wireless network adapter and a second wireless network adapter.

Clause 12: The method of any of clauses 8-11, further comprising: generating a tensor based on the channel state information, wherein inputting the channel state information into the machine-learning model comprises inputting the tensor into the machine-learning model.

Clause 13: The method of any of clauses 8-12, wherein generating the tensor comprises encoding the channel state information into a 4D tensor based on 3D signal pathways between the first set of wireless network antennas and the second set of wireless network antennas.

Clause 14: The method of any of clauses 8-13, wherein the image comprises a 3D volume of pixels, and wherein the at least one entity comprises an internal organ of an entity.

Clause 15: A computer program product comprising at least one non-transitory computer-readable medium including program instructions that, when executed by at least one computing device, cause the at least one computing device to: initiate, with a first wireless network adapter, bidirectional communication of network packets between a first set of wireless network antennas and a second set of wireless network antennas, wherein a space is defined between the first set of wireless network antennas and the second set of wireless network antennas; extract channel state information from the network packets after they are received by the first set of wireless network antennas and the second set of wireless network antennas; and generate an image of at least one entity in the space defined between the first set of wireless network antennas and the second set of wireless network antennas based on inputting the channel state information into a machine-learning model.

Clause 16: The computer program product of clause 15, wherein initiating the bidirectional communication of network packets comprises: switching the first set of wireless network antennas from operating as a transmitter to operating as a receiver at a predetermined time interval; and switching the second set of wireless network antennas from operating as the receiver to operating as the transmitter at the predetermined time interval.

Clause 17: The computer program product of clause 15 or 16, wherein the bidirectional communication of network packets between the first set of wireless network antennas and the second set of wireless network antennas is performed substantially simultaneously by the first wireless network adapter and a second wireless network adapter.

Clause 18: The computer program product of any of clauses 15-17, wherein the at least one computing device is further caused to: generate a tensor based on the channel state information, wherein inputting the channel state information into the machine-learning model comprises inputting the tensor into the machine-learning model.

Clause 19: The computer program product of any of clauses 15-18, wherein generating the tensor comprises encoding the channel state information into a 4D tensor based on 3D signal pathways between the first set of wireless network antennas and the second set of wireless network antennas.

Clause 20: The computer program product of any of clauses 15-19, wherein the image comprises a 3D volume of pixels, and wherein the at least one entity comprises an internal organ of an entity.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic diagram of a system for imaging using wireless network signals according to non-limiting embodiments;

FIG. 2 is a flow diagram of a method for imaging using wireless network signals according to non-limiting embodiments;

FIG. 3 illustrates another schematic diagram of a system for imaging using wireless network signals according to non-limiting embodiments; and

FIG. 4 illustrates example components of a computing device used in connection with non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “computing device” may refer to one or more devices configured to process data. A computing device may, in some examples, include the necessary components to receive, process, and output data, such as a processor, a display, a memory, an input device, a network interface, and/or the like. A computing device may be a processor, such as a central processing unit (CPU) or graphics processing unit (GPU), a mobile device, and/or other like devices. A computing device may also be a desktop computer, a server computer or other form of non-mobile computer. Reference to “a processor,” as used herein, may refer to a previously-recited processor that is recited as performing a previous step or function, a different processor, and/or a combination of processors. For example, as used in the specification and the claims, a first processor that is recited as performing a first step or function may refer to the same or different processor recited as performing a second step or function.

Non-limiting embodiments described herein are directed to systems, methods, and devices for imaging using wireless network signals. Through an arrangement of multiple wireless network adapters and sets of antennas, non-limiting embodiments improve upon existing wireless signal-based imaging systems. Non-limiting embodiments of the systems and methods described herein provide for safe imaging without the ionized radiation associated with CT scans. Non-limiting embodiments also allow for network hardware to be utilized to implement an imaging system in a low-cost manner. Non-limiting embodiments may also be arranged in environments where CT scans may be impracticable.

Non-limiting embodiments of the systems, methods, and devices for imaging using wireless network signals can produce images comparable to CT images (e.g., x-ray imaging) in a safe manner that can be used for regular (e.g., daily) monitoring and for early screening of cardiovascular diseases and other medical conditions. This results in a safer system that avoids the level of ionizing radiation associated with an x-ray CT scan. It will be appreciated that various other advantages are provided by non-limiting embodiments described herein.

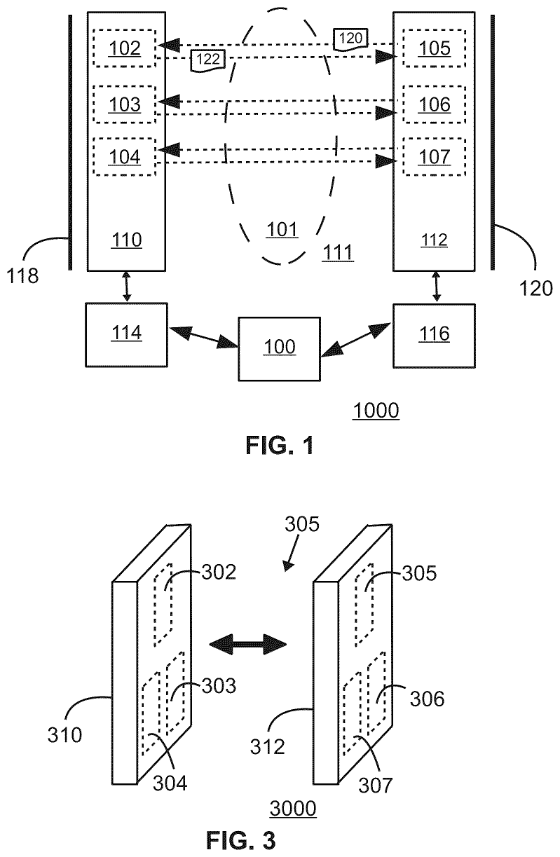

Referring now to FIG. 1, a system 1000 for imaging using wireless network signals is shown according to non-limiting embodiments. In this example, an entity 101 is being imaged. The entity may include, for example, a person or other type of animal. The entity may also include one or more internal organs and/or structures of a person or other type of animal. The system 1000 includes a first set of wireless network antennas 102, 103, 104 and a second set of wireless network antennas 105, 106, 107. Each set of antennas may include any number of antennas. In non-limiting embodiments, each set may include antennas of a plurality of antenna pairs (e.g., 102 paired with 105, 103 paired with 106, 104 paired with 107). It will be appreciated that various different antenna arrangements and numbers of antennas may be used. In non-limiting embodiments, the antennas 102-107 may be Wi-Fi® antennas. It will be appreciated that other wireless network antennas and/or protocols may be used in non-limiting embodiments.

In non-limiting embodiments, a first enclosure 110 (e.g., first housing) may contain the first set of wireless network antennas 102, 103, 104 and a second enclosure 112 (e.g., second housing) may contain and/or support the second set of wireless network antennas 105, 106, 107. The two enclosures 110, 112 may be located at a distance (e.g., several inches, feet, yards, or the like) from each other, defining a space 111 between the enclosures 110, 112. In the example of FIG. 1, the entity 101 is pictured in the space 111 between the enclosures. The space 111 may be large enough to fit a human or other type of entity, such as but not limited to 18 inches wide, 24 inches wide, 48 inches wide, or the like.

With continued reference to FIG. 1, the system 1000 may include a computing device 100 in communication with two wireless network adapters 114, 116. The wireless network adapters 114, 116 may include Wi-Fi® network adapters, as an example. However it will be appreciated that other wireless network adapters and/or protocols may be used in non-limiting embodiments. The computing device 100 may include one or more CPUs, GPUs, and/or the like, and may be located local (e.g., part of the same structure or in the same room/facility) or remote (e.g., a server computer in another location communicated with via a network) from the antennae 102-107. In non-limiting embodiments, the computing device 100 may include an embedded GPU.

In non-limiting embodiments, a frame may be used to support the two enclosures 110, 112, wireless network adapters 114, 116, and/or computing device 100. The frame may be constructed from a non-metallic material to avoid signal interference, although it will be appreciated that various types of support structures and arrangements may be used. In non-limiting embodiments, a shield 118, 120 may be arranged on at least one side of each enclosure 110, 112 and/or may be incorporated into at least one side of each enclosure 110, 112. In some non-limiting embodiments, the shield 118, 120 may be a material that is used to construct a portion of the enclosures 110, 112 (e.g., one or more sidewalls). The shield may include a metallic material configured to block and/or deflect wireless signals that may be transmitted past the antenna arrangements. The shield 118, 120 may be arranged to direct the wireless signals from the antennas in a direction toward the other set of antennas, such as in a 180 degree broadcast angle, a 120 degree broadcast angle, a 90 degree broadcast angle, a 45 degree broadcast angle, and/or the like.

Still referring to FIG. 1, in non-limiting embodiments, the computing device 100 may control the wireless network adapters 114, 116 to substantially simultaneously (e.g., at the same time or within seconds or milliseconds) communicate network packets 120, 122 in a bidirectional manner (e.g., between the wireless network adapters 114, 116). Although FIG. 1 shows two packets 120, 122 for illustration purposes, it will be appreciated that numerous packets may be communicated in a bidirectional manner. When a wireless network adapter 114, 116 receives a network packet 120, 122 from an antenna, the wireless network adapter 114, 116 and/or computing device 100 may extract data (e.g., channel state information) from the packets. The extracted data may include encoded information about properties of the wireless communication channel between the transmitter antenna and the receiver antenna for a given packet, such as data about signal propagation (e.g., amplitude and phase, channel response at different frequencies, spatial properties relating to how the signal changes across different signal paths, and/or the like). The channel state information may include assignments of different subcarrier frequencies among different pairs of antennas. In non-limiting embodiments, at least the spatial information is extracted from the channel state information of a received network packet. In non-limiting embodiments, the wireless network adapters 114, 116 may be configured to use a protocol such as 802.11, and the network packets may be Wi-Fi® packets transmitted according to such a protocol. However it will be appreciated that different wireless network protocols may be used in non-limiting embodiments.

In non-limiting embodiments, the network packets 120, 122 may be generated and/or modified to permit substantially simultaneous broadcasting and receiving. This may be achieved by using two or more wireless network adapters 114,116 to act as both transmitters and receivers. For example, the operating system kernel and/or device driver(s) handling the network communication from the computing device 100 may determine that a Media Access Control (MAC) address or other unique identifier that a packet is addressed to does not exist within the system (e.g., is not an expected MAC address) and prevent the packet from being transmitted by the corresponding wireless network adapter. For example, the use of multiple wireless network adapters as both transmitters and receivers may prevent the packets from being transmitted to a MAC address that matches the other wireless network adapter.

To address this, in non-limiting embodiments, the network packet may be modified at the data link layer to change the data link code, therefore modifying the output interface of the wireless network adapter 114, 116 operating as a transmitter. By modifying the data link code, the network packet may be sent to an antenna (e.g., 102-107) for transmission instead of being processed through a weaving system and/or internal buffer of the system that may prevent transmission due to the destination MAC address (e.g., a MAC address of the other wireless network adapter), output channel, and/or other parameter of the network packet. For example, the output communication channel may not be permitted by the Wi-Fi® standard or other communication protocol. In non-limiting embodiments, the data link code may be modified by including a unique identifier for the wireless network adapter 114, 116 being used, such that the unique identifier can be used to differentiate between different wireless network adapters. Such an arrangement permits the system 1000 to differentiate between packets sent with the first wireless network adapter 114 and packets sent with the second wireless network adapter 116. In non-limiting embodiments, such a modification may involve modifying the driver(s) for the wireless network adapters 114, 116 to modify the network packet prior to being transmitted.

With continued reference to FIG. 1, after the channel state information is extracted from the network packets, the channel state information may be input into a machine-learning model trained to generate a 3D volume of pixels based on the input. In non-limiting embodiments, the channel state information may be used to generate one or more tensors that represent the channel state information and can be input into the machine-learning model. In non-limiting embodiments, the same machine-learning model (e.g., a subset of layers) or a different machine-learning model may be used to generate the tensor based on the channel state information. In non-limiting embodiments, the tensor may be generated by encoding the channel state information into a 4-dimensional (4D) tensor based on 3D signal pathways between the first set of wireless network antennas 102, 103, 104 and the second set of wireless network antennas 105, 106, 107 represented in the channel state information extracted from the network packets.

In non-limiting embodiments, the machine-learning model may be trained based on training data including manually and/or automatically labeled 3D pixel volumes or other 3D object representations with corresponding channel state information. The machine-learning model may also be trained based on usage of the system over time. In non-limiting embodiments, x-ray data of internal organs may be used to train the machine-learning network.

In non-limiting embodiments, each set of wireless network antennas may include three (3) individual antennas, although it will be appreciated that any number of antennas may be used. A total of six (6) antennas (3×3) results in nine (9) transmission single direction signal paths and a total of eighteen (18) signal paths. In some non-limiting embodiments, additional sets of wireless network antennas may be used such that there may be a total of two, four, eight, ten, and/or the like sets of antennas.

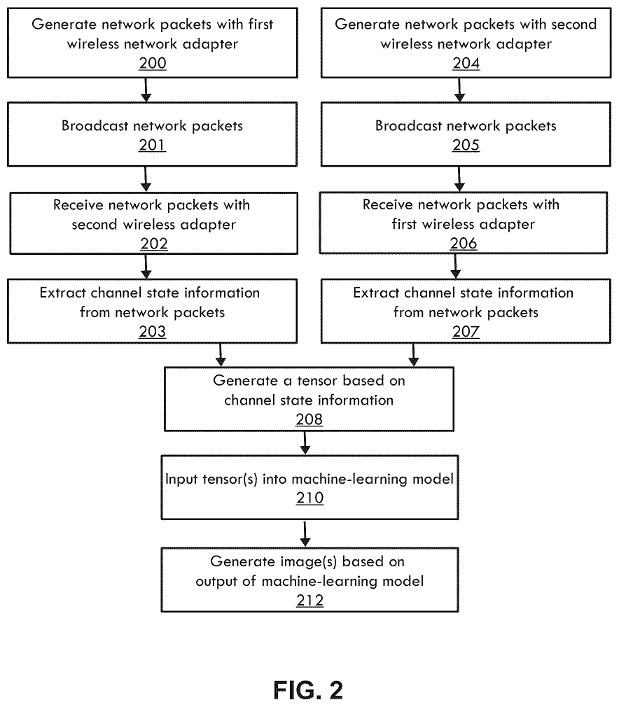

Referring now to FIG. 2, a method for imaging using wireless network signals is shown according to non-limiting embodiments. It will be appreciated that the order of the steps shown in FIG. 2 is for illustrative purposes only and that non-limiting embodiments may involve more steps, fewer steps, different steps, and/or a different order of steps. In non-limiting embodiments, one or more steps may be automatically performed in response to performance and/or completion of a preceding step.

Steps 200 and 204 may be performed substantially simultaneously. At step 200, the first wireless network adapter is used to generate network packets to be broadcasted so that they are received by antennas associated with the second wireless network adapter. For example, the first wireless network adapter may generate network packets and broadcast the network packets at step 201 from a first set of wireless antennas. At step 204, the second wireless network adapter is used to generate a different set of network packets to be broadcasted so that they are received by antennas associated with the first wireless network adapter. For example, the second wireless network adapter may generate network packets and broadcast the network packets at step 205 from the second set of wireless antennas. Steps 201 and 205 may also be performed substantially simultaneously, and both wireless network adapters may act as a transmitter and receiver at the same time. The network packets generated at steps 200 and 204 may have a modified data link code. For example, the network packets may identify the wireless network adapter associated with the packet (e.g., the adapter that transmits the packet).

At steps 202 and 206, network packets may be received by respective wireless network adapters. For example, the second wireless adapter may receive packets broadcast by the first wireless adapter at step 200, and the first wireless adapter may receive packets broadcast by the second wireless adapter at step 204. Steps 202 and 206 may be performed substantially simultaneously. At step 203, channel state information may be extracted from the network packets received by the second wireless adapter (e.g., received by a second set of antennas controlled by the second wireless adapter). At step 207, channel state information may be extracted from the network packets received by the first wireless adapter (e.g., received by a first set of antennas controlled by the first wireless adapter). Steps 207 and 203 may be performed substantially simultaneously.

With continued reference to FIG. 2, at step 208 one or more tensors may be generated based on the extracted channel state information. Generating a tensor may include structuring and/or formatting the extracted channel state information. It will be appreciated that other data representations (e.g., objects) may be used to encode and/or represent the channel state information extracted from the network packets. The tensor or other representation may be in the form of a matrix, as an example. In non-limiting embodiments, generating the tensor(s) may include encoding the tensor(s) spatially to match the spatial layout of one or more images. This may be performed with a spatial encoding function that maps the spatial information from the network packets to a known layout of a 3D environment. In non-limiting embodiments, the encoding may map the spatial information and/or other channel state information from the network packets to a 4D spatial-aware tensor corresponding to the 3D signal pathways among the pairs of antennas. In non-limiting embodiments, a machine-learning model may be used to generate the tensor(s) from the channel state information. In non-limiting embodiments, a first tensor or first set of sensors may be generated from the network packets received with the second wireless network adapter at step 202 and the information extracted from the packets at step 203 and be combined with a second tensor or second set of tensors that may be generated from the network packets received with the first wireless network adapter at step 206 and the information extracted from the packets at step 207. In non-limiting embodiments, tensors may be combined that are received within a predetermined time interval (e.g., 0.1 seconds, 1 second, 10 seconds, and/or the like).

With continued reference to FIG. 2, at step 210, the tensor(s) are input into a machine-learning model. The machine-learning model may be trained to output a 3D volume of pixels or other 3D representation of one or more entities positioned between the sets of antennas. The machine-learning model may output a location of detected entities and/or objects and labels for the pixels and/or sets of images. At step 212, one or more images (e.g., still images, videos, and/or the like) may be generated by generating visual boundaries or labels corresponding to the labels and/or by overlaying the output of the machine-learning model onto one or more images. In non-limiting embodiments, the pixels may be intensified to identify boundaries, such as bones having a brightest intensity, soft tissues having a gray or medium intensity, and air or other environment having a dark gray or lowest intensity. The 3D volume may be visualized as equally spaced gray-level slices along three orthogonal axes, although various other formats are possible.

Referring now to FIG. 3, a system 3000 for imaging using wireless network signals is shown according to non-limiting embodiments. FIG. 3 shows a perspective view of two enclosures 310, 312 separated by a distance that defines a space 305 between the enclosures. The first enclosure 310 includes a first set of antennas 302, 303, 304. The second enclosure 312 includes a second set of antennas 305, 306, 307. The antennas may be within (e.g., inside) the respective enclosures. The space 305 may be wide enough to fit an entity (such as a person) between the two enclosures 310, 312. Although FIG. 3 shows three antennas in each enclosure 310, 312 it will be appreciated that any number of antennas may be used in non-limiting embodiments.

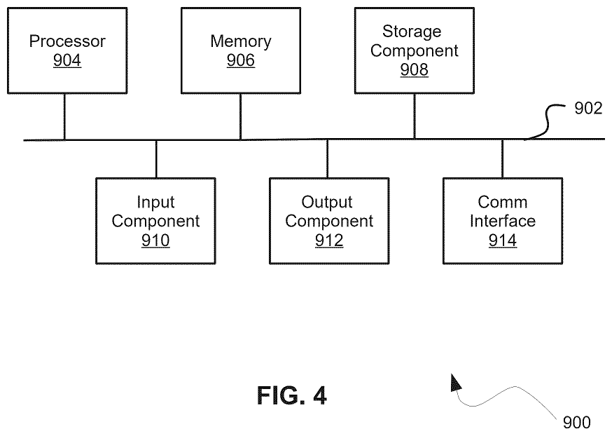

Referring now to FIG. 4, shown is a diagram of example components of a computing device 900 for implementing and performing the systems and methods described herein according to non-limiting embodiments. For example, the computing device 900 may correspond to the computing device 100 shown in FIG. 1. In some non-limiting embodiments, device 900 may include additional components, fewer components, different components, or differently arranged components than those shown in FIG. 4. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 4, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a photo-sensor, a thermal sensor, an electromagnetic field sensor, a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system for imaging using wireless network signals comprising:
a first set of wireless network antennas;
a second set of wireless network antennas arranged a distance from the first set of wireless network antennas, wherein a space is defined between the first set of wireless network antennas and the second set of wireless network antennas; and
at least one computing device in communication with the first set of wireless network antennas and the second set of wireless network antennas, the at least one computing device configured to:
initiate, with a first wireless network adapter, bidirectional communication of network packets between the first set of wireless network antennas and the second set of wireless network antennas;
extract channel state information from the network packets after they are received by the first set of wireless network antennas and the second set of wireless network antennas; and
generate an image of at least one entity in the space defined between the first set of wireless network antennas and the second set of wireless network antennas based on inputting the channel state information into a machine-learning model.

2. The system of claim 1, further comprising:
a first enclosure comprising the first set of wireless network antennas; and
a second enclosure comprising the second set of wireless network antennas.

3. The system of claim 1, wherein initiating the bidirectional communication of network packets comprises:
switching the first set of wireless network antennas from operating as a transmitter to operating as a receiver at a predetermined time interval; and
switching the second set of wireless network antennas from operating as the receiver to operating as the transmitter at the predetermined time interval.

4. The system of claim 1, further comprising a first wireless network adapter and a second wireless network adapter, wherein the bidirectional communication of network packets between the first set of wireless network antennas and the second set of wireless network antennas is performed substantially simultaneously by the first wireless network adapter and the second wireless network adapter.

5. The system of claim 1, wherein the at least one computing device is further configured to:
generate a tensor based on the channel state information, wherein inputting the channel state information into the machine-learning model comprises inputting the tensor into the machine-learning model.

6. The system of claim 5, wherein generating the tensor comprises encoding the channel state information into a 4D tensor based on 3D signal pathways between the first set of wireless network antennas and the second set of wireless network antennas.

7. The system of claim 1, wherein the image comprises a 3-dimensional volume of pixels, and wherein the at least one entity comprises an internal organ of an entity.

8. A method comprising:
initiating, with a first wireless network adapter, bidirectional communication of network packets between a first set of wireless network antennas and a second set of wireless network antennas, wherein a space is defined between the first set of wireless network antennas and the second set of wireless network antennas;
extracting channel state information from the network packets after they are received by the first set of wireless network antennas and the second set of wireless network antennas; and
generating an image of at least one entity in the space defined between the first set of wireless network antennas and the second set of wireless network antennas based on inputting the channel state information into a machine-learning model.

9. The method of claim 8, further comprising arranging the first set of wireless network antennas in a first enclosure and the second set of wireless network antennas in a second enclosure.

10. The method of claim 8, wherein initiating the bidirectional communication of network packets comprises:
switching the first set of wireless network antennas from operating as a transmitter to operating as a receiver at a predetermined time interval; and
switching the second set of wireless network antennas from operating as the receiver to operating as the transmitter at the predetermined time interval.

11. The method of claim 8, wherein the bidirectional communication of network packets between the first set of wireless network antennas and the second set of wireless network antennas is performed substantially simultaneously by a first wireless network adapter and a second wireless network adapter.

12. The method of claim 8, further comprising:
generating a tensor based on the channel state information, wherein inputting the channel state information into the machine-learning model comprises inputting the tensor into the machine-learning model.

13. The method of claim 12, wherein generating the tensor comprises encoding the channel state information into a 4D tensor based on 3D signal pathways between the first set of wireless network antennas and the second set of wireless network antennas.

14. The method of claim 8, wherein the image comprises a 3D volume of pixels, and wherein the at least one entity comprises an internal organ of an entity.

15. A computer program product comprising at least one non-transitory computer-readable medium including program instructions that, when executed by at least one computing device, cause the at least one computing device to:
initiate, with a first wireless network adapter, bidirectional communication of network packets between a first set of wireless network antennas and a second set of wireless network antennas, wherein a space is defined between the first set of wireless network antennas and the second set of wireless network antennas;
extract channel state information from the network packets after they are received by the first set of wireless network antennas and the second set of wireless network antennas; and
generate an image of at least one entity in the space defined between the first set of wireless network antennas and the second set of wireless network antennas based on inputting the channel state information into a machine-learning model.

16. The computer program product of claim 15, wherein initiating the bidirectional communication of network packets comprises:
switching the first set of wireless network antennas from operating as a transmitter to operating as a receiver at a predetermined time interval; and
switching the second set of wireless network antennas from operating as the receiver to operating as the transmitter at the predetermined time interval.

17. The computer program product of claim 15, wherein the bidirectional communication of network packets between the first set of wireless network antennas and the second set of wireless network antennas is performed substantially simultaneously by the first wireless network adapter and a second wireless network adapter.

18. The computer program product of claim 15, wherein the at least one computing device is further caused to:
generate a tensor based on the channel state information, wherein inputting the channel state information into the machine-learning model comprises inputting the tensor into the machine-learning model.

19. The computer program product of claim 18, wherein generating the tensor comprises encoding the channel state information into a 4D tensor based on 3D signal pathways between the first set of wireless network antennas and the second set of wireless network antennas.

20. The computer program product of claim 15, wherein the image comprises a 3D volume of pixels, and wherein the at least one entity comprises an internal organ of an entity.
